(19) United States
(12) Patent Application Publication
(10) Pub. No.: US 2022/0119306 A1
(43) Pub. Date: Apr. 21, 2022

(54) CHEMICALLY STRENGTHENED GLASS AND MANUFACTURING METHOD THEREFOR

(71) Applicant: AGC Inc., Tokyo (JP)

(72) Inventors: Shusaku AKIBA, Tokyo (JP); Takumi UMADA, Tokyo (JP)

(73) Assignee: AGC Inc., Tokyo (JP)

(21) Appl. No.: 17/561,493

(22) Filed: Dec. 23, 2021

Related U.S. Application Data
(63) Continuation of application No. PCT/JP2020/016055, filed on Apr. 9, 2020.

(30) Foreign Application Priority Data
Jun. 26, 2019 (JP) 2019-118969

(51) Int. Cl. C03C 21/00; C03C 3/083; C03C 10/00

(52) U.S. Cl. CPC C03C 21/002; C03C 2204/00; C03C 10/0027; C03C 3/083

(57) ABSTRACT

The present invention relates to a chemically strengthened glass having a first main surface, and satisfying the following (1a) to (4a): (1a) in a thickness range of [depth where a compressive stress value is 0]±10 μm, a stress curve has a gradient of −15 MPa/μm to −3 MPa/μm and an Na concentration curve has a gradient of 0.02/μm to 0.12/μm in terms of absolute value; (2a) the Na concentration curve, in a sheet-thickness-direction range lying between the first main surface and the depth where the compressive stress value is 0, has a monotonously decreasing gradient; (3a) the chemically strengthened glass has a thickness of 1 mm or less; and (4a) the chemically strengthened glass includes Li₂O in an amount of 10 mol % or more in mole percentage on an oxide basis.

### CROSS-REFERENCE TO RELATED APPLICATIONS

This is a bypass continuation of International Patent Application No. PCT/JP2020/016055, filed on Apr. 9, 2020, which claims priority to Japanese Patent Application No. 2019-118969, filed on Jun. 26, 2019. The contents of these applications are hereby incorporated by reference in their entireties.

### TECHNICAL FIELD

The present invention relates to a chemically strengthened glass and a method of producing the chemically strengthened glass.

### BACKGROUND ART

Cover glasses constituted of chemically strengthened glasses are used for the purposes of protecting the display devices such as portable telephones, smartphones, and tablet devices, and enhancing the appearance attractiveness of them.

In chemically strengthened glasses, there is a tendency that the greater the surface compressive stress (value) (CS) or the depth of compressive stress layer (DOL), the higher the strength. Meanwhile, internal tensile stress (value) (CT) generates within the glass so as to be balanced with the compressive stress of the glass surface layer and, hence, the greater the CS or DOL, the higher the CT. In glasses having a high CT, there is a heightened possibility that, upon reception of damage, the glasses might break into a tremendous number of fragments and scatter the fragments.

Patent Document 1 describes a feature in which surface compressive stress can be increased while inhibiting internal tensile stress from increasing, by performing two-stage chemical strengthening. Specifically, Patent Document 1 discloses, for example, a method in which a KNO₃/NaNO₃ salt mixture having a low K concentration is used in first-stage chemical strengthening and a KNO₃/NaNO₃ salt mixture having a high K concentration is used in second-stage chemical strengthening.

Patent Document 2 discloses a lithium-containing glass having relatively high surface compressive stress and a relatively large depth of compressive stress layer, obtained by two-stage chemical strengthening. The lithium-containing glass can have increased values of CS and DOL while inhibiting CT from increasing, owing to a two-stage chemical strengthening treatment in which a sodium salt is used in a first-stage chemical strengthening treatment and a potassium salt is used in a second-stage chemical strengthening treatment.

Patent Document 3 describes a glass article including a metal oxide concentration gradient, and shows a chemical-strengthening stress profile of a conventional lithium-free glass (Patent Document 3; FIG. 2).

### CITATION LIST

### Patent Literature

Patent Document 1: U.S. Patent Application Publication No. 2015/0259244

Patent Document 2: JP-T-2013-520388 (The term “JP-T” as used herein means a published Japanese translation of a PCT patent application.)

Patent Document 3: JP-A-2019-510726

### SUMMARY OF INVENTION

### Technical Problems

A stress profile of a conventional lithium-free chemically strengthened glass is shown in FIG. 1 and a stress profile of a conventional lithium-containing chemically strengthened glass is shown in FIG. 2. In the case of chemically strengthening a lithium-containing glass, it is necessary, for attaining an increase in surface compressive stress, to perform ion exchange down to a sheet-thickness-direction deep portion, since the rate of lithium diffusion is high and stress relaxation occurs. Because of this, the conventional chemical strengthening of a lithium-containing glass results in a stress profile which is parabolic as shown in FIG. 2; the chemical strengthening has a tendency that not only the surface compressive stress but also the tensile stress increases. There also is a problem in that Na—Li exchange occurs substantially down to the sheet-thickness center.

Two-stage chemical strengthening has hitherto been performed in order to mitigate such problems. However, the two-stage chemical strengthening necessitates complicated treatments and has a problem concerning production efficiency. In addition, in cases when the lithium-containing glass has an increased lithium content (Li₂O content) in mole percentage on an oxide basis (for example, 10 mol % or more on an oxide basis), the chemically strengthened glass has a strong tendency to have a parabolic stress profile and an increased tensile stress. It is hence desired to effectively enhance compressive stress.

An object of the present invention is to provide, under such circumstances, a lithium-containing chemically strengthened glass which has a stress profile similar to that of conventional lithium-free glasses and nevertheless has a high surface compressive stress and in which the compressive stress has been introduced only into the vicinity of a surface layer, and a manufacturing method of the chemically strengthened glass.

### Solution to the Problems

The present inventors made investigations on those problems and, as a result, have discovered that a chemically strengthened glass containing Li₂O in an amount of 10 mol % or more can be made to have enhanced glass-surface ductility and improved strength by regulating an Na concentration gradient and a stress gradient therein. The present invention has been completed based on the findings.

The present invention is as follows.

1. A chemically strengthened glass having a first main surface, a second main surface facing the first main surface, and an end portion in contact with both the first main surface and the second main surface, and

satisfying the following (1a) to (4a) when compressive stress values of an inner portion of the glass are expressed using a depth from the first main surface as a variable:

(1a) in a thickness range of [depth where a compressive stress value is 0]±10 μm, a stress curve has a gradient of −15 MPa/μm to −3 MPa/μm and an Na concentration curve defined below has a gradient of 0.02/μm to 0.12/μm in terms of absolute value,

where the Na concentration curve is an Na concentration curve obtained by converting a sheet-thickness-direction Na ion concentration profile of the chemically strengthened glass determined with an EPMA into a curve expressed in mole percentage on an oxide basis;

(2a) the Na concentration curve, in a sheet-thickness-direction range lying between the first main surface and the depth where the compressive stress value is 0, has a monotonously decreasing gradient;
(3a) the chemically strengthened glass has a thickness of 1 mm or less; and
(4a) the chemically strengthened glass includes Li₂O in an amount of 10 mol % or more in mole percentage on an oxide basis.

2. The chemically strengthened glass according to 1 above, in which, when the thickness of the chemically strengthened glass is t (μm), the stress curve has an average gradient of less than 1 MPa/μm in terms of absolute value in a sheet-thickness-direction range lying between a sheet-thickness center tc (μm) and (tc−0.20×t) (μm).

3. The chemically strengthened glass according to 1 or 2 above, in which in a sheet-thickness-direction range lying between the first main surface and the depth where the compressive stress value is 0, a compressive stress curve determined with birefringence imaging system Abrio-IM, manufactured by Tokyo Instruments, Inc., contains an inflection point and the Na concentration curve contains no inflection point.

4. The chemically strengthened glass according to 3 above, in which in a sheet-thickness-direction range lying between a position having a depth of 10 um from the first main surface and the depth where the compressive stress value is 0, the compressive stress curve contains an inflection point.

5. The chemically strengthened glass according to any one of 1 to 4 above, which is a glass ceramic.

6. The chemically strengthened glass according to 5 above, in which the glass ceramic has a degree of crystallization of 10% or more.

7. The chemically strengthened glass according to 5 or 6 above, in which the glass ceramic includes lithium metasilicate crystals.

8. The chemically strengthened glass according to any one of 5 to 7 above, having a haze for transmitted-light as converted into a value corresponding to a thickness of 0.7 mm determined through a measurement method according to JIS K 7136 (2000) of 0.01-0.2%.

9. The chemically strengthened glass according to any one of 5 to 8 above, having a visible-light transmittance as converted into a value corresponding to a thickness of 0.7 mm of 85% or more.

10. A method of producing a chemically strengthened glass, the method including chemically strengthening a glass that has a first main surface, a second main surface facing the first main surface, and an end portion in contact with both the first main surface and the second main surface, has a thickness of 1 mm or less, and includes Li₂O in an amount of 10 mol % or more in mole percentage on an oxide basis,

in which the chemical strengthening is chemical strengthening with a strengthening salt including sodium and having a potassium content of less than 5 mass %, and

the chemically strengthened glass to be obtained satisfies the following (1b) and (2b) when compressive stress values of an inner portion of the glass are expressed using a depth from the first main surface as a variable:

(1b) in a thickness range of [depth where compressive stress value is 0]±10 a stress curve has a gradient of −15 MPa/μm to −3 MPa/μm and an Na concentration curve defined below has a gradient of 0.02/μm to 0.12/μm in terms of absolute value,

where the Na concentration curve is an Na concentration curve obtained by converting a sheet-thickness-direction Na ion concentration profile of the chemically strengthened glass determined with an EPMA into a curve expressed in mole percentage on an oxide basis; and

(2b) the Na concentration curve, in a sheet-thickness-direction range lying between the first main surface and the depth where the compressive stress value is 0, has a monotonously decreasing gradient.

11. The method of producing a chemically strengthened glass according to 10 above, in which the glass is a glass ceramic.

12 The method of producing a chemically strengthened glass according to 11 above, in which the glass ceramic includes, in mole percentage on an oxide basis:

40-65% of SiO₂;

0-10% of Al₂O₃;

20-40% of Li₂O;

0-10% of Na₂O; and

0.1-10% of K₂O.

13. The method of producing a chemically strengthened glass according to 11 or 12 above, in which the glass ceramic has a visible-light transmittance as converted into a value corresponding to a thickness of 0.7 mm of 85% or more.

14. The method of producing a chemically strengthened glass according to any one of 11 to 13 above, in which the glass ceramic includes lithium metasilicate crystals.

### ADVANTAGEOUS EFFECTS OF INVENTION

The chemically strengthened glass of the present invention has an Na concentration gradient in a specific range and a stress gradient in a specific range. Because of this, the chemically strengthened glass, although containing Li₂O in an amount of 10 mol % or more on an oxide basis, has a stress profile similar to that of conventional lithium-free glasses, is inhibited from fracturing upon reception of damage, and is excellent in terms of strength and weatherability.

### BRIEF DESCRIPTION OF DRAWINGS

FIG. 1 is a diagram showing one example of a stress profile of a conventional lithium-free chemically strengthened glass.

FIG. 2 is a diagram showing one example of a stress profile of a conventional lithium-containing chemically strengthened glass.

FIG. 3 is a diagram showing one embodiment of a stress profile of a chemically strengthened glass of the present invention.

FIG. 4A and FIG. 4B are diagrams showing embodiments of ion concentration profiles of the chemically strengthened glass of the present invention. FIG. 4A is a diagram showing signal intensities of main ions in Example 1, and FIG. 4B is a diagram showing a calculated Na ion concentration profile.

FIG. 5A and FIG. 5B are diagrammatic views illustrating how to prepare a sample for measuring the surface compressive stress (CS) of a chemically strengthened glass. FIG. 5A shows a sample before being polished, and FIG. 5B shows a thinned sample obtained by polishing.

### DESCRIPTION OF EMBODIMENTS

The chemically strengthened glass of the present invention is described in detail below, but the present invention is not limited to the following embodiments and can be modified at will within the gist of the present invention.

In this description, the term “chemically strengthened glass” means a glass which has undergone a chemical strengthening treatment. The term “glass for chemical strengthening” means a glass which has not undergone a chemical strengthening treatment.

In this description, the glass composition of a glass for chemical strengthening is sometimes called the base composition of a chemically strengthened glass. In chemically strengthened glasses, a compressive stress layer has usually been formed in glass surface portions by ion exchange and, hence, a portion which has not undergone the ion exchange has a glass composition that is identical with the base composition of the chemically strengthened glass. Also, in a portion which has undergone the ion exchange, the concentrations of components other than alkali metal oxides basically remain unchanged.

In this description, the composition of each glass is expressed in mole percentage on an oxide basis, and “mol %” is often expressed simply by “%”. Furthermore, symbol “−” indicating a numerical range is used in the sense of including the numerical values set force before and after the “−” as a lower limit value and an upper limit value.

The expression “containing substantially no X” used for a glass composition means that the composition does not contain X except the one from any unavoidable impurity which was contained in a raw material, etc., that is, X has not been incorporated on purpose. The content thereof in the glass composition is, for example, less than 0.1 mol %, except for the case where X is a transition-metal oxide or the like which causes coloration.

In this description, “stress profile” is a pattern showing compressive stress values using the depth from a glass surface as a variable. Negative values of compressive stress mean tensile stress. “Depth of compressive stress layer (DOC)” is a depth at which the compressive stress value (CS) is zero. The term “internal tensile stress value (CT)” means a tensile stress value as measured at a depth which is ½ the glass sheet-thickness t.

In general, a stress profile is often determined using an optical-waveguide surface stress meter (e.g., FSM-6000, manufactured by Orihara Industrial Co., Ltd.). However, the optical-waveguide surface stress meter, because of the principle of measurement, is usable in stress measurements only when the refractive index decreases from the surface toward the inside. As a result, the stress meter cannot be used for measuring the compressive stress of a glass obtained by chemically strengthening a lithium aluminosilicate glass with a sodium salt. In this description, a stress profile hence is determined mainly using a scattered-light photoelastic stress meter (e.g., SLP-1000, manufactured by Orihara Industrial Co., Ltd.). With a scattered-light photoelastic stress meter, stress values can be measured regardless of a refractive-index distribution of the inner portion of the glass. However, the scattered-light photoelastic stress meter is apt to be affected by light scattered by the surface and it is hence difficult to precisely measure stress values of a portion near the glass surface. With respect to a surface-layer portion extending to a depth of 10 μm from the surface, stress values can be estimated from measured values for a deeper portion by extrapolation using a complementary error function. It is also possible to measure stress values by examining a thinned sample with, for example, birefringence imaging system Abrio-IM, manufactured by Tokyo Instruments, Inc., in the manner which will be described later.

### 1. Chemically Strengthened Glass

The chemically strengthened glass of the present invention is a chemically strengthened glass sheet having a first main surface, a second main surface, which faces the first main surface, and an end portion in contact with both the first main surface and the second main surface and

satisfying the following (1) to (4) in cases when compressive stress values of an inner portion of the glass are expressed using a depth from the first main surface as a variable.

(1) In a sheet-thickness-direction range of [depth where compressive stress value is 0]±10 μm, a stress curve has a gradient of −15 MPa/μm to −3 MPa/μm and an Na concentration curve, which is defined below, has a gradient of 0.02/μm to 0.12/μm in terms of absolute value,

where the Na concentration curve is an Na concentration curve obtained by converting a sheet-thickness-direction Na ion concentration profile of the chemically strengthened glass sheet determined with an EPMA into a curve expressed in mole percentage on an oxide basis.

(2) The Na concentration curve, in a sheet-thickness-direction range lying between the first main surface and the depth where the compressive stress value is 0, has a monotonously decreasing gradient.
(3) The chemically strengthened glass sheet has a thickness of 1 mm or less.
(4) The chemically strengthened glass sheet contains Li₂O in an amount of 10 mol % or more in mole percentage on an oxide basis.

### Stress Profile and Na Concentration Profile

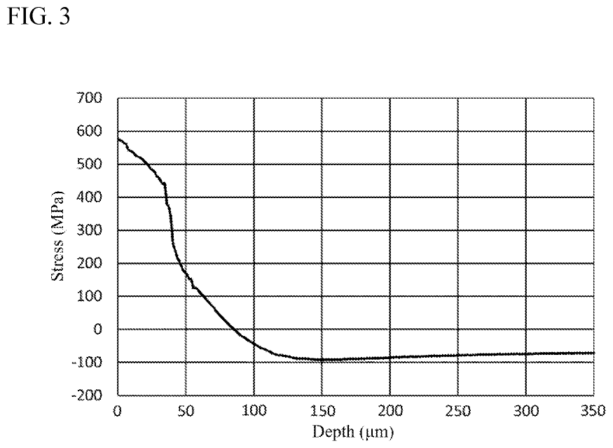

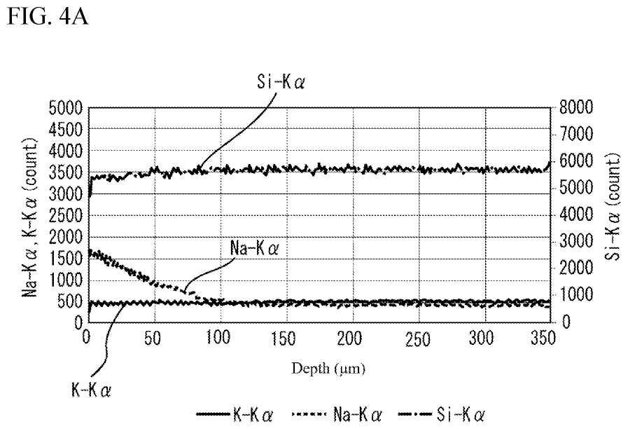

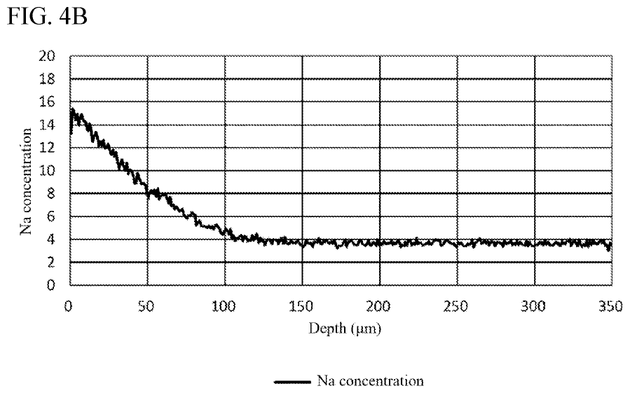

FIG. 3 is a diagram showing one embodiment of a stress profile of a chemically strengthened glass of the present invention. The stress profile shown in FIG. 3 is a profile of one main surface. In the present invention, the stress profile of one main surface and that of the other main surface may be the same or different. FIG. 4A and FIG. 4B are diagrams showing embodiments of ion concentration profiles of the chemically strengthened glass of the present invention.

The chemically strengthened glass of the present invention satisfies that in the sheet-thickness-direction range of [depth where compressive stress value is 0]±10 a stress curve has a gradient of −15 MPa/μm to −3 MPa/μm and that an Na concentration curve has a gradient of 0.02/μm to 0.12/μm in terms of absolute value.

In the present invention, the term “Na concentration curve” means an Na concentration curve obtained by converting a sheet-thickness-direction Na ion concentration profile of the chemically strengthened glass sheet determined with an EPMA (electron probe micro analyzer) into a curve expressed in mole percentage on an oxide basis.

In a stress profile, the depth at which the compressive stress value is 0 represents a depth of compressive stress layer (DOL). The DOL of a chemically strengthened glass can be suitably regulated by regulating the conditions for the chemical strengthening, the composition of the glass, etc. The DOL of the chemically strengthened glass of the present invention is the depth of a portion in the stress profile where the stress is zero from the glass surface, and is a value measured with a scattered-light photoelastic stress meter (e.g., SLP-1000, manufactured by Orihara Industrial Co., Ltd.). It is also possible to measure the depth by examining a thinned sample with, for example, birefringence imaging system Abrio-IM, manufactured by Tokyo Instruments, Inc., in the manner which will be described later.

For the chemically strengthened glass of the present invention, the stress curve in the sheet-thickness-direction range of [depth where compressive stress value is 0]±10 μm has a gradient of −15 MPa/μm to −3 MPa/μm, preferably −13 MPa/μm to −3.5 MPa/μm, more preferably −11 MPa/μm to −4 MPa/μm. Since the gradient of the stress curve in the sheet-thickness-direction range of [depth where compressive stress value is 0]±10 μm is −15 MPa/μm to −3 MPa/μm, the energy attributable to the concentration gradient is inhibited from dissipating and can be effectively converted to stress. Hence, a sufficient surface compressive stress is obtained and the chemically strengthened glass shows excellent strength.

In the chemically strengthened glass of the present invention, the Na concentration curve in the sheet-thickness-direction range of [depth where compressive stress value is 0]±10 μm has a gradient of 0.02/μm to 0.12/μm in terms of absolute value, preferably 0.03/μm to 0.11/μm, more preferably 0.04/μm to 0.10/μm. Since the gradient of the Na concentration curve in the sheet-thickness-direction range of [depth where compressive stress value is 0]±10 μm is 0.02/μm to 0.12/μm in terms of absolute value, the tensile stress can be inhibited from increasing.

In the chemically strengthened glass of the present invention, the Na concentration curve in the sheet-thickness-direction range lying between the first main surface and the depth where the compressive stress value is 0 has a monotonously decreasing gradient. Since the gradient of the Na concentration curve in that range is a monotonously decreasing gradient, the chemically strengthened glass can be inhibited from having an increased tensile stress and from fracturing upon reception of damage. In the present invention, the expression “the Na concentration curve has a monotonously decreasing gradient” means that the Na concentration curve, at any point within that range, has a gradient which is not zero and has a negative inclination from the glass surface toward an inner portion of the glass.

In an embodiment of the chemically strengthened glass of the present invention, a value obtained by dividing the gradient of the stress curve in the sheet-thickness-direction range of [depth where compressive stress value is 0]±10 μm by the gradient of the Na concentration curve in that range is preferably 80-200, more preferably 90-180, still more preferably 100-150. In cases when the value obtained by dividing the gradient of the stress curve in the sheet-thickness-direction range of [depth where compressive stress value is 0]±10 μm by the gradient of the Na concentration curve in that range is 80-200, the energy attributable to the concentration gradient is more effectively inhibited from dissipating and can be effectively converted to stress. This chemically strengthened glass hence shows a sufficient surface compressive stress and can be inhibited from increasing in tensile stress and from fracturing upon reception of damage.

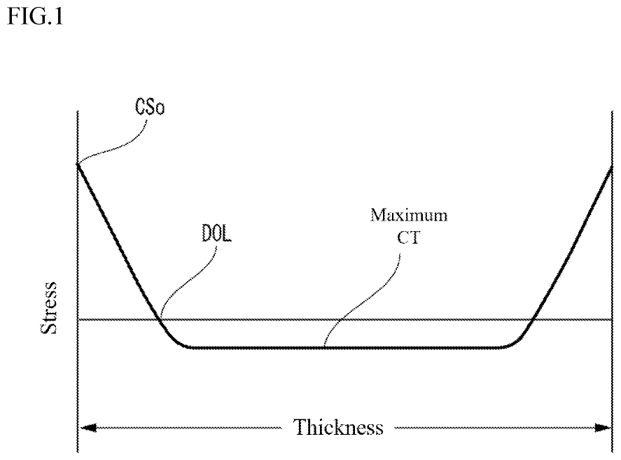

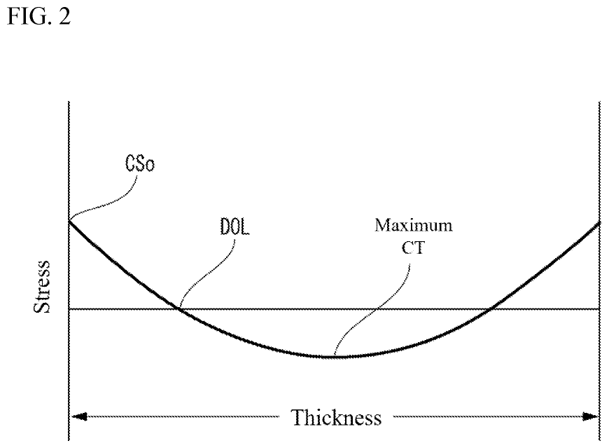

In an embodiment of the chemically strengthened glass of the present invention, in cases when the thickness thereof is t (μm) and a sheet-thickness center is expressed by tc (μm), then the stress curve in the sheet-thickness-direction range lying between the sheet-thickness center tc (μm) and (tc−0.20×t) (μm) has an average gradient in terms of absolute value of preferably less than 1 MPa/μm, more preferably 0.9 MPa/μm or less, still more preferably 0.8 MPa/μm or less. In cases when the stress curve in that sheet-thickness-direction range has an average gradient of less than 1 MPa/μm in terms of absolute value, this chemically strengthened glass has a substantially flat tensile stress profile like the conventional lithium-free chemically strengthened glass shown in FIG. 1. Thus, this chemically strengthened glass can have an increased surface compressive stress while being inhibited from increasing in internal tensile stress.

A gradient in terms of absolute value of the stress curve at any point in the thickness range of tc±0.20 t (μm) is preferably less than 1 MPa/μm, more preferably 0.9 MPa/μm or less, still more preferably 0.8 MPa/μm or less. In cases when the stress curve in that thickness range has a gradient less than 1 MPa/μm in terms of absolute value, this chemically strengthened glass has a substantially flat stress profile in a wider tensile-stress region and can have an enlarged surface-compression region while being inhibited from increasing in internal tensile stress.

In an embodiment of the chemically strengthened glass of the present invention, it is preferable that in the sheet-thickness-direction range lying between the first main surface and the depth where the compressive stress value is 0, a compressive stress curve determined with birefringence imaging system Abrio-IM, manufactured by Tokyo Instruments, Inc., contains an inflection point and the Na concentration curve contains no inflection point.

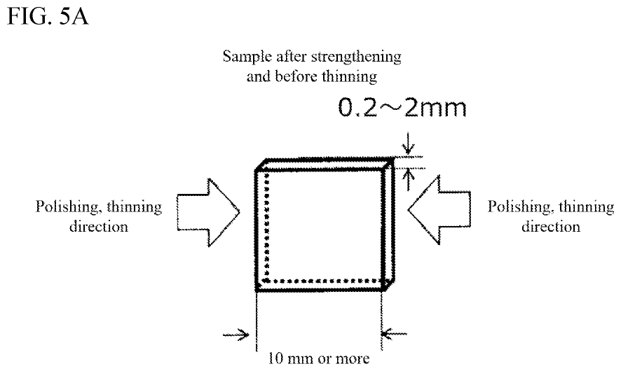

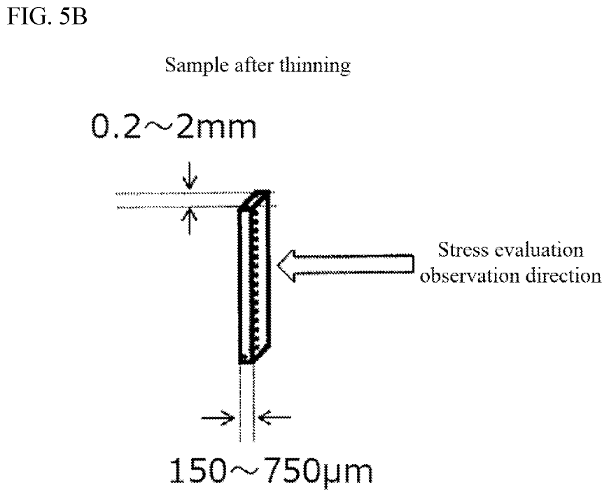

A measurement of compressive stress with birefringence imaging system Abrio-IM, manufactured by Tokyo Instruments, Inc., is made in the following manner. FIG. 5A and FIG. 5B are diagrammatic views illustrating how to prepare a sample for measuring the surface compressive stress (CS) of a chemically strengthened glass. FIG. 5A shows a sample before being polished, and FIG. 5B shows a thinned sample obtained by polishing. Cross-sections of a chemically strengthened glass having a size of 10 mm×10 mm or more and a thickness of about 0.2-2 mm are polished to thin the glass to a thickness in the range of 150-750 μm as shown in FIG. 5B.

The procedure of the polishing is as follows. The cross-sections are ground with a grinding wheel having electrodeposited #1000 diamond grains to a thickness larger by about 50 μm than a desired thickness, subsequently ground with a grinding wheel having electrodeposited #2000 diamond grains to a thickness larger by about 10 μm than the desired thickness, and finally mirror-polished with cerium oxide to the desired thickness. The thus-prepared sample having a thickness reduced to about 200 μm is irradiated using monochromatic light of λ=546 nm as a light source and the transmitted light is examined with the birefringence imaging system to determine the retardation of the chemically strengthened glass. A stress is calculated from the obtained value using the following expression (1).

$$F = δ / ( C \times t ’ ) \qquad Expression ( 1 )$$

In expression (1), F represents stress (MPa), δ represents retardation (nm), C represents photoelastic constant (nm cm⁻¹ MPa), and t′ represents the thickness (cm) of the sample.

In the present invention, the term “inflection point” means a point on a curve where the secondary differentiation of the curve results in zero. That is, that term means a point where the curvature of the curve changes in sign. It is preferable that before the differentiation is performed, measurement noises are diminished by, for example, smoothing. For example, the curve can be processed beforehand using the known Savitzky-Golay method.

If a glass sheet deflects upon reception of impact and the deflection amount is large, then high tensile stress is imposed on a glass surface, resulting in a fracture of the glass. In this description, this fracture is called “bending-mode glass fracture”.

In cases when in the sheet-thickness-direction range lying between the first main surface and the depth where the compressive stress value is 0, the compressive stress curve contains an inflection point and the Na concentration curve contains no inflection point, then stress can have a relaxation tendency while maintaining a concentration gradient especially in the glass sheet surface. Such compressive stress curve and such Na concentration curve indicate that an excess portion of the energy attributable to the concentration gradient has sufficiently dissipated. Consequently, a sufficient amount of compressive stress can be introduced into the glass surface and, simultaneously therewith, the chemically strengthened glass can be inhibited from suffering bending-mode glass fracture and from decreasing in weatherability. From the standpoint of further improving the strength, it is preferable in one embodiment of the chemically strengthened glass of the present invention that the compressive stress curve contains an inflection point in a sheet-thickness-direction range lying between a position having a depth of 10 μm from the first main surface and the depth where the compressive stress value is 0.

In cases when such a stress curve is to be imparted to a lithium-free glass, a method hitherto is to conduct annealing or the like after ion exchange to cause the concentration gradient to relax. This method, however, has a drawback in that the energy itself attributable to the concentration gradient relaxes and, hence, the stress relaxes excessively, resulting in a considerable deterioration in surface stress. Meanwhile, glasses containing Li₂O in an amount of 10 mol % or more have a high ion diffusion rate as stated hereinabove, and there has been no known method for introducing stress until stress relaxation occurs in the surface, in particular in a relatively wide range in the vicinity of the surface.

The chemically strengthened glass of the present invention is produced by subjecting a lithium aluminosilicate glass to an ion exchange treatment. As compared with sodium aluminosilicate glasses which have conventionally been extensively used as glasses for chemical strengthening, lithium aluminosilicate glasses tend to have a large fracture toughness value and is less apt to break even upon reception of flaws. In addition, lithium aluminosilicate glasses is less apt to fracture vigorously even when having an increased glass-surface compressive stress value.

One embodiment of the chemically strengthened glass of the present invention has a CS₀ of preferably 500 MPa or more, more preferably 550 MPa or more, still more preferably 600 MPa or more. In cases when the CS₀ thereof is 500 MPa or more, tensile stress caused by dropping is countervailed and this renders the glass less apt to fracture and can inhibit the glass from suffering a bending-mode fracture. In addition, since the sum of compressive stress in a glass surface layer is constant, too high a CS₀ value results in a decrease in CS₅₀, which is the CS of an inner portion of the glass. Consequently, from the standpoint of preventing the glass from fracturing upon reception of impact, the CS₀ thereof is preferably 1,000 MPa or less, more preferably 950 MPa or less, still more preferably 900 MPa or less.

One embodiment of the chemically strengthened glass of the present invention has a CS₅₀ of preferably 150 MPa or more, more preferably 170 MPa or more, still more preferably 180 MPa or more. In cases when the CS₅₀ thereof is 150 MPa or more, this glass can have improved strength. However, too high a CS₅₀ results in an increase in internal tensile stress CT to make the glass prone to fracture. From the standpoint of inhibiting the glass from fracturing (fracturing explosively upon reception of damage), the CS₅₀ thereof is preferably 250 MPa or less, more preferably 240 MPa or less, still more preferably 230 MPa or less.

The depth (DOL) at which the compressive stress value is 0 is preferably 0.2 t or less, more preferably 0.19 t or less, still more preferably 0.18 t or less, because too large values thereof with respect to the thickness t [unit: μm] result in an increase in CT. Specifically, in cases when the sheet-thickness t is, for example, 0.8 mm, the DOL is preferably 160 μm or less. Meanwhile, from the standpoint of improving the strength, the DOL is preferably 0.06 t or more, more preferably 0.08 t or more, still more preferably 0.10 t or more, especially preferably 0.12 t or more.

A glass having a large fracture toughness value has a high CT limit and is hence less apt to fracture vigorously even when having a high surface compressive stress introduced thereinto by chemical strengthening. From the standpoint of inhibiting fracture upon reception of damage, in one embodiment of the chemically strengthened glass of the present invention, the base glass has a fracture toughness value of preferably 0.8 MPa·m^{1/2} or more, more preferably 0.85 MPa·m^{1/2} or more, still more preferably 0.9 MPa·m^{1/2} or more. The fracture toughness value thereof is usually 2.0 MPa·m^{1/2} or less, typically 1.5 MPa·m^{1/2} or less.

Fracture toughness value can be measured, for example, using a DCDC method (Acta metall. mater., Vol. 43, pp. 3453-3458, 1995). An easy method for evaluating fracture toughness value is an indentation method. Examples of methods for regulating the fracture toughness to a value within that range include a method in which the degree of crystallization, fictive temperature, or the like is regulated by regulating crystallization conditions (time period of heat treatment and temperature therefor) for producing a glass ceramic, glass composition, cooling rate, etc. Specifically, in the case of a glass ceramic, the degree of crystallization of the glass ceramic, which will be described later, is regulated to preferably 15% or more, more preferably 18% or more, still more preferably 20% or more. From the standpoint of ensuring a transmittance, the degree of crystallization of the glass ceramic is preferably 60% or less, more preferably 55% or less, still more preferably 50% or less.

The weatherability of a chemically strengthened glass can be evaluated through a weatherability test. The chemically strengthened glass of the present invention has a change in haze through 120-hour standing at 80% humidity and 80° C. of preferably 5% or less (that is, |(haze [%] after the test)−(haze [%] before the test)|≤5), more preferably 4% or less, still more preferably 3% or less. Haze is measured using a hazemeter by a method according to JIS K7136 (2000).

The chemically strengthened glass of the present invention may have any of shapes other than sheet shapes, in accordance with products, uses, etc. to which the glass is applied. The glass sheet may have, for example, a trimmed shape in which the periphery has different thicknesses. Configurations of the glass sheet are not limited to these. For example, the two main surfaces may not be parallel with each other, or some or all of one or each of the two main surfaces may be a curved surface. More specifically, the glass sheet may be, for example, a flat glass sheet having no warpage or may be a curved glass sheet having curved surfaces.

The chemically strengthened glass of the present invention can be used as cover glasses for mobile electronic appliances such as portable telephones, smartphones, portable digital assistants (PDAs), and tablet devices. The chemically strengthened glass of the present invention is useful also as the cover glasses of electronic appliances not intended to be carried, such as televisions (TVs), personal computers (PCs), and touch panels. Furthermore, the chemically strengthened glass of the present invention is useful as building materials, e.g., window glasses, table tops, interior trims for motor vehicles, airplanes, etc., and cover glasses for these.

Since the chemically strengthened glass of the present invention can be made to have a shape other than the flat sheet shape by performing bending or shaping before or after the chemical strengthening, the chemically strengthened glass is useful also in applications such as housings having a curved shape.

### Thickness

The chemically strengthened glass of the present invention has a thickness (t) of 1 mm or less, preferably 0.9 mm or less, more preferably 0.8 mm or less, especially preferably 0.7 mm or less. Meanwhile, from the standpoint of obtaining sufficient strength, the thickness thereof is, for example, 0.1 mm or more, preferably 0.2 mm or more, more preferably 0.4 mm or more, still more preferably 0.5 mm or more.

### Lithium-Containing Glass

The chemically strengthened glass of the present invention contains Li₂O in an amount of 10 mol % or more in mole percentage on an oxide basis. Li₂O is a component which produces surface compressive stress by ion exchange, and is essential. The content of Li₂O is preferably 15 mol % or more, more preferably 20 mol % or more, still more preferably 25 mol % or more. Meanwhile, from the standpoint of enabling the chemically strengthened glass to retain chemical durability, the content of Li₂O is preferably 50 mol % or less, more preferably 45 mol % or less, still more preferably 40 mol % or less.

The chemically strengthened glass of the present invention is a lithium-containing glass, preferably a lithium aluminosilicate glass. So long as the lithium aluminosilicate glass is a glass including SiO₂, Al₂O₃, and Li₂O, this glass is not particularly limited in its form. Examples thereof include a glass ceramic and an amorphous glass, and it is preferable that the chemically strengthened glass is a glass ceramic because this glass can have enhanced fracture toughness. The glass ceramic and the amorphous glass are described below.

### Glass Ceramic

In the case where the lithium-containing glass of the present invention is a glass ceramic, a preferred embodiment thereof includes, in mole percentage on an oxide basis,

40-65% of SiO₂,

0-10% of Al₂O₃,

20-40% of Li₂O,

0-10% of Na₂O, and

0-10% of K₂O.

The glass ceramic is obtained by heat-treating an amorphous glass, which will be explained later, to crystallize the glass. The glass composition of the glass ceramic is the same as the composition of the amorphous glass which has not undergone the crystallization, and will be explained later in the section Amorphous Glass.

The glass ceramic preferably has a total visible-light transmittance which is a transmittance for total visible light including diffused transmitted light of 85% or more as converted into a value corresponding to a thickness of 0.7 mm. This glass ceramic having such total visible-light transmittance makes images on the screen of the display highly visible when used as the cover glass of a portable display. The total visible-light transmittance thereof is more preferably 88% or more, still more preferably 90% or more. The higher the total visible-light transmittance, the more the glass ceramic is preferred. Usually, however, the total visible-light transmittance thereof is 91% or less. The total visible-light transmittances of ordinary amorphous glasses are about 90%. Conversion into a value corresponding to a thickness of 0.7 mm is as follows.

In the case where a glass ceramic having a sheet-thickness of t [mm] has a total light transmittance of 100×T [%] and a one-side surface thereof has a surface reflectance of 100×R [%], then the relationship T=(1−R)²×exp(−αt), which contains constant α, is derived by using Lambert-Beer's law.

The expression is rewritten to express the α with R, T, and t, and t is taken as 0.7 mm. Thus, since R is constant regardless of the sheet-thickness, the total light transmittance T_{0.7} corresponding to a thickness of 0.7 mm can be calculated as

$${T}_{0.7} = 100 \times {T}^{0.7 / t} / {( 1 - R )}^{\hat{}} ( 1.4 / t - 2 ) [ \% ]$$

where X\hat{ }Y represents X^{Y}.

The surface reflectance may be determined by a calculation from refractive index or may be actually measured.

Meanwhile, in the case of a glass having a sheet-thickness t larger than 0.7 mm, this glass may be polished, etched, or otherwise processed to regulate the sheet-thickness to 0.7 mm to conduct an actual measurement of the total light transmittance.

The transmission haze as converted into a value corresponding to a thickness of 0.7 mm is preferably 1.0% or less, more preferably 0.4% or less, still more preferably 0.3% or less, especially preferably 0.2% or less, most preferably 0.15% or less. The lower the transmission haze, the more the glass ceramic is preferred. However, in cases when the degree of crystallization is lowered or the crystal-grain diameter is reduced in order to reduce the transmission haze, this results in a decrease in mechanical strength. From the standpoint of attaining increased mechanical strength, the transmission haze as converted into a value corresponding to a thickness of 0.7 mm is preferably 0.02% or more, more preferably 0.03% or more. Values of transmission haze are measured by a method according to JIS K7136 (2000). The haze as converted into a value corresponding to a thickness of 0.7 mm can be determined in the following manner.

In cases when a glass ceramic having a sheet-thickness of t [mm] has a total visible-light transmittance of 100×T [%] and a transmission haze of 100×H [%], then the following relationship is derived, in which the constant α used above is used.

$$dH / dt \text{\textasciitilde} exp ( - α t ) \times ( 1 - H )$$

That is, it can be thought that as the sheet-thickness increases, the transmission haze increases in proportion to an internal linear transmittance.

By integration thereof, the transmission haze H_{0.7} as converted into a value corresponding to a thickness of 0.7 mm can be calculated as follows:

$${H}_{0.7} = 100 \times [ 1 - {( 1 - H )}^{\hat{}} \{ ( {( 1 - R )}^{2} - {T}_{0.7} ) / ( {( 1 - R )}^{2} - T ) \} ] [ \% ]$$

where “X\hat{ }Y” represents “X^{Y}”.

Meanwhile, in the case of a glass having a sheet-thickness t larger than 0.7 mm, this glass may be polished, etched, or otherwise processed to regulate the sheet-thickness to 0.7 mm to conduct an actual measurement of the transmission haze.

The glass ceramic has a value of Y in the XYZ color system of preferably 87 or more, more preferably 88 or more, still more preferably 89 or more, especially preferably 90 or more, the value of Y being calculated from a spectrum of total transmitted light including diffused transmitted light. In the case where the chemically strengthened glass of the present invention is for use as the cover glass of a portable display, it is preferable that the coloration of the glass itself is as little as possible, in order for the glass to heighten the reproducibility of colors to be displayed, when used on the display screen side or to maintain design attractiveness when used on the housing side. From this standpoint, the glass ceramic has an excitation purity Pe of preferably 1.0 or less, more preferably 0.75 or less, still more preferably 0.5 or less, especially preferably 0.35 or less, most preferably 0.25 or less.

In the case where a strengthened glass obtained by strengthening the glass ceramic is to be used as the cover glass of a portable display, it is preferable that this strengthened glass has a high-grade texture different from the texture of plastics. From the standpoint of attaining this quality, the glass ceramic has a dominant wavelength λd of preferably 580 nm or less and a refractive index of preferably 1.52 or more, more preferably 1.55 or more, still more preferably 1.57 or more.

The glass ceramic is preferably a glass ceramic containing lithium metasilicate crystals. Lithium metasilicate crystals are crystals represented by Li₂SiO₃ and generally giving an X-ray powder diffraction spectrum which has diffraction peaks at Bragg angles (2θ) of 26.98°±0.2, 18.88°±0.2, and 33.05°±0.2.

Glass ceramics containing lithium metasilicate crystals have high fracture toughness values as compared with general amorphous glasses and are less apt to fracture vigorously even after high compressive stress is provided therein by chemical strengthening. There are cases where amorphous glasses in which lithium metasilicate crystals can be precipitated undergo precipitation of lithium disilicate therein depending on heat treatment conditions, etc.

The lithium disilicate is represented by Li₂Si₂O₅ and is crystals generally giving an X-ray powder diffraction spectrum which has diffraction peaks at Bragg angles (2θ) of 24.89°±0.2, 23.85°±0.2, and 24.40°±0.2. In the case where the glass ceramic contains lithium disilicate crystals, the lithium disilicate crystals preferably have a crystal grain diameter, as determined from the width of an X-ray diffraction peak using the Scherrer equation, of 45 nm or less, because transparency is easy to obtain. The crystal grain diameter of the lithium disilicate crystals is more preferably 40 nm or less. Although the Scherrer equation includes a shape factor, the factor in this case may be represented by the dimensionless number of 0.9.

However, in cases when the glass ceramic contains both lithium metasilicate crystals and lithium disilicate crystals, this glass ceramic is prone to have reduced transparency. It is hence preferable that the glass ceramic contains no lithium disilicate. The expression “containing no lithium disilicate” means that no diffraction peaks for lithium disilicate crystals are detected in the X-ray diffraction spectrum.

The degree of crystallization of the glass ceramic is preferably 5% or more, more preferably 10% or more, still more preferably 15% or more, especially preferably 20% or more, from the standpoint of enhancing the mechanical strength. From the standpoint of heightening the transparency, the degree of crystallization thereof is preferably 70% or less, more preferably 60% or less, especially preferably 50% or less. Low degrees of crystallization are advantageous also in that this glass ceramic is easy to, for example, bend with heating.

The degree of crystallization can be calculated from X-ray diffraction intensity by the Rietveld method. The Rietveld method is described in The Crystallographic Society of Japan “Crystal Analysis Handbook” editorial board, ed., “Crystal Analysis Handbook”, Kyoritsu Shuppan, pp. 492-499, 1999.

The precipitated crystals in the glass ceramic have an average grain diameter of preferably 80 nm or less, more preferably 60 nm or less, still more preferably 50 nm or less, especially preferably 40 nm or less, most preferably 30 nm or less. The average grain diameter of the precipitated crystals is determined from images obtained with a transmission electron microscope (TEM). The average grain diameter of the precipitated crystals can be estimated from images obtained with a scanning electron microscope (SEM).

The glass ceramic has an average coefficient of thermal expansion at 50-350° C. of preferably 90×10⁻⁷/° C. or more, more preferably 100×10⁻⁷/° C. or more, still more preferably 110×10⁻⁷/° C. or more, especially preferably 120×10⁻⁷/° C. or more, most preferably 130×10⁻⁷/° C. or more.

In case where the coefficient of thermal expansion thereof is too high, there is a possibility that the glass ceramic might crack due to a difference in thermal expansion coefficient during chemical strengthening. Because of this, the average coefficient of thermal expansion thereof is preferably 160×10⁻⁷/° C. or less, more preferably 150×10⁻⁷/° C. or less, still more preferably 140×10⁻⁷/° C. or less. In addition, such coefficients of thermal expansion make the chemically strengthened glass suitable for use as the supporting substrates of semiconductor packages including resinous components in a large proportion.

The glass ceramic has a high hardness because it contains crystals. The glass ceramic hence is less apt to receive scratches and has excellent wear resistance. From the standpoint of enhancing the wear resistance, the glass ceramic has a Vickers hardness of preferably 600 or more, more preferably 700 or more, still more preferably 730 or more, especially preferably 750 or more, most preferably 780 or more. Too high a hardness makes the glass difficult to process. The Vickers hardness of the glass ceramic hence is preferably 1,100 or less, more preferably 1,050 or less, still more preferably 1,000 or less.

The glass ceramic has a Young's modulus of preferably 85 GPa or more, more preferably 90 GPa or more, still more preferably 95 GPa or more, especially preferably 100 GPa or more, from the standpoint of inhibiting the glass from being warped by chemical strengthening. There are cases where the glass ceramic is polished before being used. From the standpoint of facilitating the polishing, the Young's modulus thereof is preferably 130 GPa or less, more preferably 125 GPa or less, still more preferably 120 GPa or less.

The glass ceramic has a fracture toughness value of preferably 0.8 MPa·m^{1/2} or more, more preferably 0.85 MPa·m^{1/2} or more, still more preferably 0.9 MPa·m^{1/2} or more. This is because the chemically strengthened glass obtained by chemically strengthening the glass ceramic having such a fracture toughness value is less apt to scatter fragments upon breakage.

In the case where the lithium aluminosilicate glass in the present invention is a glass ceramic, a preferred embodiment thereof includes, in mole percentage on an oxide basis, 40-60% SiO₂, 0.5-10% Al₂O₃, 10-50% Li₂O, 0-4% P₂O₅, 0-6% ZrO₂, 0-7% Na₂O, and 0-5% K₂O. That is, it is preferable that an amorphous glass (hereinafter sometimes referred to as “crystallizable amorphous glass”) including, in mole percentage on an oxide basis, 40-60% SiO₂, 0.5-10% Al₂O₃, 15-50% Li₂O, 0-4% P₂O₅, 0-6% ZrO₂, 0-7% Na₂O, and 0-5% K₂O is heat-treated and crystallized.

### Crystallizable Amorphous Glass

A preferred embodiment of the amorphous glass of the present invention includes, in mole percentage on an oxide basis, 40-60% SiO₂, 0.5-10% Al₂O₃, 10-50% Li₂O, 0-4% P₂O₅, 0-6% ZrO₂, 0-7% Na₂O, and 0-5% K₂O.

This glass composition is explained below.

In the crystallizable amorphous glass, SiO₂ is a component which forms the network structure of the glass. SiO₂ is also a component which enhances the chemical durability and is a constituent component of lithium metasilicate as precipitated crystals. The content of SiO₂ is preferably 40% or more. The content of SiO₂ is more preferably 42% or more, still more preferably 45% or more. From the standpoint of enabling sufficiently high stress to be produced by chemical strengthening, the content of SiO₂ is preferably 60% or less, more preferably 58% or less, still more preferably 55% or less.

Al₂O₃ is a component which enhances the surface compressive stress to be produced by chemical strengthening, and is essential. The content of Al₂O₃ is preferably 0.5% or more. From the standpoint of enhancing the stress to be produced by chemical strengthening, the content of Al₂O₃ is more preferably 1% or more, still more preferably 2% or more. Meanwhile, from the standpoint of obtaining a glass ceramic having a reduced transmission haze, the content of Al₂O₃ is preferably 10% or less, more preferably 8% or less, still more preferably 6% or less.

Li₂O is a component which produces surface compressive stress through ion exchange. Li₂O is a constituent component of lithium silicate crystals, lithium aluminosilicate crystals, and lithium phosphate crystals, and is essential. The content of Li₂O is 10% or more, preferably 15% or more, more preferably 20% or more, still more preferably 25% or more. Meanwhile, from the standpoint of making the glass retain chemical durability, the content of Li₂O is preferably 50% or less, more preferably 45% or less, still more preferably 40% or less.

Na₂O is a component which improves the meltability of the glass. Although Na₂O is not essential, the content thereof is preferably 0.1% or more, more preferably 0.5% or more, still more preferably 1% or more, especially preferably 2% or more. In case where Na₂O is contained in too large an amount, lithium metasilicate crystals are less apt to precipitate or chemical strengthening properties is decreased. Consequently, the content of Na₂O is preferably 7% or less, more preferably 6% or less, still more preferably 5% or less.

K₂O is a component which lowers the melting temperature of the glass like Na₂O, and may be contained. The content of K₂O, when it is contained, is preferably 0.1% or more, more preferably 0.5% or more, still more preferably 1% or more, yet still more preferably 1.5% or more, especially preferably 2% or more. In case where K₂O is contained in too large an amount, chemical strengthening properties is decreased. Consequently, the content of K₂O is preferably 5% or less, more preferably 4% or less, still more preferably 3% or less, especially preferably 2% or less.

The total content of Na₂O and K₂O, Na₂O+K₂O, is preferably 0.5% or more, more preferably 1% or more. Meanwhile, Na₂O+K₂O is preferably 7% or less, more preferably 6% or less, still more preferably 5% or less.

P₂O₅, although not essential in the case of a glass ceramic containing lithium silicate or lithium aluminosilicate, has the effect of promoting phase separation in the glass to accelerate crystallization and may be contained. P₂O₅ is an essential component in the case of a glass ceramic containing lithium phosphate crystals. The content P₂O₅, when it is contained, is preferably 0.5% or more, more preferably 1% or more, still more preferably 1.5% or more. Meanwhile, in case where the content of P₂O₅ is too high, the glass not only is prone to undergo phase separation during melting but also has considerably reduced acid resistance. The content of P₂O₅ is preferably 5% or less, more preferably 4% or less, still more preferably 3% or less.

ZrO₂ is a component which can constitute crystal nuclei in a crystallization treatment, and may be contained. The content of ZrO₂ is preferably 1% or more, more preferably 2% or more, still more preferably 2.5% or more, especially preferably 3% or more. Meanwhile, from the standpoint of inhibiting devitrification during melting, the content of ZrO₂ is preferably 6% or less, more preferably 5.5% or less, still more preferably 5% or less.

TiO₂ is a component which can constitute crystal nuclei in a crystallization treatment, and may be contained. Although TiO₂ is not essential, the content thereof, when it is contained, is preferably 0.5% or more, more preferably 1% or more, still more preferably 2% or more, especially preferably 3% or more, most preferably 4% or more. Meanwhile, from the standpoint of inhibiting devitrification during melting, the content of TiO₂ is preferably 10% or less, more preferably 8% or less, still more preferably 6% or less.

SnO₂ serves to accelerate formation of crystal nuclei and may be contained. Although SnO₂ is not essential, the content thereof, when it is contained, is preferably 0.5% or more, more preferably 1% or more, still more preferably 1.5% or more, especially preferably 2% or more. Meanwhile, from the standpoint of inhibiting devitrification during melting, the content of SnO₂ is preferably 6% or less, more preferably 5% or less, still more preferably 4% or less, especially preferably 3% or less.

Y₂O₃ is a component which renders the chemically strengthened glass less apt to scatter fragments upon fracture, and may be contained. The content of Y₂O₃ is preferably 1% or more, more preferably 1.5% or more, still more preferably 2% or more, especially preferably 2.5% or more, exceedingly preferably 3% or more. Meanwhile, from the standpoint of inhibiting devitrification during melting, the content of Y₂O₃ is preferably 5% or less, more preferably 4% or less.

B₂O₃, although not essential, is a component which improves the chipping resistance of the glass for chemical strengthening or of the chemically strengthened glass and which improves the meltability, and may be contained. The content of B₂O₃, when it is contained, is preferably 0.5% or more, more preferably 1% or more, still more preferably 2% or more, from the standpoint of improving the meltability. Meanwhile, in case where the content of B₂O₃ exceeds 5%, striae are prone to occur during melting, resulting in a decrease in the quality of the glass for chemical strengthening. The content of B₂O₃ is hence preferably 5% or less. The content of B₂O₃ is more preferably 4% or less, still more preferably 3% or less, especially preferably 2% or less.

BaO, SrO, MgO, CaO, and ZnO are components which improve the meltability of the glass, and may be contained. In the case where one or more of these components are contained, the total content of BaO, SrO, MgO, CaO, and ZnO, BaO+SrO+MgO+CaO+ZnO, is preferably 0.5% or more, more preferably 1% or more, still more preferably 1.5% or more, especially preferably 2% or more. Meanwhile, the content BaO+SrO+MgO+CaO+ZnO is preferably 8% or less, more preferably 6% or less, still more preferably 5% or less, especially preferably 4% or less, because too high a content thereof results in a decrease in ion exchange rate.

BaO, SrO, and ZnO, among those components, may be incorporated in order to heighten the refractive index of the residual glass to a value close to that of the precipitated crystal phase and thereby improve the transmittance of the glass ceramic and lower the haze thereof. In this case, the total content thereof, BaO+SrO+ZnO, is preferably 0.3% or more, more preferably 0.5% or more, still more preferably 0.7% or more, especially preferably 1% or more. Meanwhile, these components sometimes lower the rate of ion exchange. From the standpoint of improving the chemical strengthening properties, BaO+SrO+ZnO is preferably 2.5% or less, more preferably 2% or less, still more preferably 1.7% or less, especially preferably 1.5% or less.

CeO₂ may be contained. CeO₂ has an effect of oxidizing the glass and sometimes inhibits coloring. The content of CeO₂, when it is contained, is preferably 0.03% or more, more preferably 0.05% or more, still more preferably 0.07% or more. In the case of using CeO₂ as an oxidizing agent, the content of CeO₂ is preferably 1.5% or less, more preferably 1.0% or less, from the standpoint of heightening the transparency.

In cases when the strengthened glass is to be used in a colored state, a coloring component may be added so long as the addition thereof does not inhibit the desired properties from being imparted by chemical strengthening. Suitable examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

The content of such coloring components is preferably up to 1% in total. In the case where the glass is desired to have a higher visible-light transmittance, it is preferable to substantially contain none of these components.

SO₃, a chloride, a fluoride, etc. may be suitably contained as a refining agent for glass melting. It is preferable that no As₂O₃ is contained. In cases when Sb₂O₃ is contained, the content thereof is preferably 0.3% or less, more preferably 0.1% or less. It is most preferable that Sb₂O₃ is not contained.

Hereinafter, the content in mol % of a component A is expressed by C-A. In the present invention, the crystals precipitated as a crystal phase may be any crystals. However, from the standpoint of obtaining a glass ceramic having higher transparency, the mol % ratio between Li₂O and SiO₂, C—Li₂O/C—CiO₂, is preferably 0.4 or more, more preferably 0.45 or more, still more preferably 0.5 or more. Meanwhile, that mol % ratio is preferably 0.85 or less, more preferably 0.80 or less, still more preferably 0.75 or less. This makes it easy to obtain lithium metasilicate and, as a result, a glass ceramic having high transparency is obtained through grain-diameter control.

C—Li₂O/C—Na₂O is preferably 4 or more, more preferably 8 or more, still more preferably 12 or more, and is preferably 30 or less, more preferably 28 or less, still more preferably 25 or less. This makes it easy to obtain a stress profile in which compressive stress has been sufficiently introduced by chemical strengthening and the surface stress has relaxed.

### 2. Method of Producing the Chemically Strengthened Glass

One embodiment of methods of producing the chemically strengthened glass of the present invention is a method in which the crystallizable amorphous glass, for example, is heat-treated to obtain a glass ceramic and the obtained glass ceramic is chemically strengthened to produce the chemically strengthened glass.

### Production of Amorphous Glass

An amorphous glass can be produced, for example, by the following method. The production method shown below is an example of producing a sheet-shaped chemically strengthened glass.

Raw materials for glass are mixed so as to obtain a glass having a preferred composition and the mixture is heated and melted in a glass melting furnace. Thereafter, the molten glass is homogenized by bubbling, stirring, addition of a refining agent, etc., formed into a glass sheet having a given thickness by a known forming method, and then annealed. Alternatively, the molten glass may be formed into a block shape, annealed, and then cut into a sheet shape.

Examples of forming methods for producing a sheet-shaped glass include a float process, pressing process, a fusion process, and a downdraw process. The float process is preferred especially in producing a large glass sheet. Continuous processes other than the float process, such as, for example, a fusion process and a downdraw process, are also preferred.

### Crystallization Treatment

In the case where the lithium aluminosilicate glass in the present invention is a glass ceramic, the glass ceramic is obtained by heat-treating a crystallizable amorphous glass obtained by the procedure described above.

It is preferable that the heat treatment is a two-stage heat treatment in which the crystallizable amorphous glass is heated from room temperature to a first treatment temperature, held at this temperature for a certain time period, and then held at a second treatment temperature, which is higher than the first treatment temperature, for a certain time period.

In the case of performing the two-stage heat treatment, the first treatment temperature is preferably in a temperature range where the glass composition has a high crystal nucleus formation rate, and the second treatment temperature is preferably in a temperature range where the glass composition has a high crystal growth rate. The time period of holding at the first treatment temperature is preferably long so that a sufficient number of crystal nuclei are formed. The formation of a large number of crystal nuclei results in crystals having a reduced size, thereby yielding a highly transparent glass ceramic.

The first treatment temperature is, for example, 450-700° C., and the second treatment temperature is, for example, 600-800° C. The glass is held at the first treatment temperature for 1-6 hours and then held at the second treatment temperature for 1-6 hours.

The glass ceramic obtained by the procedure described above is ground and polished according to need to form a glass-ceramic sheet. In cases when the glass-ceramic sheet is to be cut into a given shape and size or chamfered, it is preferred to perform the cutting or chamfering before a chemical strengthening treatment is given thereto. This is because a compressive stress layer is formed also in the end surfaces by the subsequent chemical strengthening treatment.

### Production of Chemically Strengthened Glass

The chemically strengthened glass of the present invention is produced by chemically strengthening a lithium-containing glass. The lithium-containing glass preferably has the composition described hereinabove.

The lithium-containing glass can be produced by an ordinary method. For example, raw materials for the components of the glass are mixed and the mixture is heated and melted in a glass melting furnace. Thereafter, the glass is homogenized by a known method, formed into a desired shape, e.g., a glass sheet, and then annealed.

Examples of methods for forming the glass include a float process, pressing process, a fusion process, and a downdraw process. The float process is especially preferred because it is suitable for mass production. Continuous processes other than the float process, such as, for example, a fusion process and a downdraw process, are also preferred.

Thereafter, the formed glass is ground and polished according to need to form a glass substrate. In cases when the glass substrate is to be cut into a given shape and size or is to be chamfered, it is preferred to perform the cutting or chamfering of the glass substrate before the chemical strengthening treatment which will be described later is given thereto. This is because a compressive stress layer is formed also in the end surfaces by the subsequent chemical strengthening treatment.

It is preferable that the chemical strengthening in the method of the present invention for producing a chemically strengthened glass is chemical strengthening with a strengthening salt which includes sodium and has a potassium content of less than 5 mass %. In the method of the present invention for producing a chemically strengthened glass, the chemical strengthening treatment may include two or more stages. However, one-stage strengthening is preferred from the standpoint of heightening the production efficiency.

Treatment conditions for the chemical strengthening treatment may be suitably selected while taking account of the composition (properties) of the glass, kind of the molten salt, desired properties to be imparted by the chemical strengthening, etc. The chemical strengthening treatment is conducted, for example, by immersing the glass sheet for 0.1-500 hours in a molten salt, e.g., sodium nitrate, heated to 360-600° C. The heating temperature of the molten salt is preferably 375-500° C. The period of immersion of the glass sheet in the molten salt is preferably 0.3-200 hours.

The strengthening salt to be used in the method of the present invention for producing a chemically strengthened glass is a strengthening salt which includes sodium and has a potassium content of less than 5 mass %. The potassium content in the strengthening salt is preferably 2 mass % or less, and it is more preferable that the strengthening salt contains substantially no potassium. The expression “containing substantially no potassium” means that the strengthening salt does not contain potassium at all or that the strengthening salt may contain potassium as an impurity which has come unavoidably thereinto during production.

Examples of the strengthening salt include nitrates, sulfates, carbonates, and chlorides. Examples of the nitrates, among these, include lithium nitrate and sodium nitrate. Examples of the sulfates include lithium sulfate and sodium sulfate. Examples of the carbonates include lithium carbonate and sodium carbonate. Examples of the chlorides include lithium chloride, sodium chloride, cesium chloride, and silver chloride. One of these strengthening salts may be used alone, or two or more thereof may be used in combination.

### EXAMPLES

The present invention is described below using Examples, but the present invention is not limited by the following Examples. With respect to examination results in the tables, each blank indicates that the property was not determined. Examples 1 to 4 are working examples, and Example 5 is a comparative example.

### Preparation and Evaluation of Amorphous Glasses

Raw materials for glass were mixed so as to result in each of the glass compositions shown in Table 1 in terms of mol % on an oxide basis, and the mixtures were melted and polished to prepare glass sheets. The raw materials for glass were suitably selected from among general raw materials for glass such as oxides, hydroxides, and carbonates, and weighed out so as to result in 900 g each of glasses. Each mixture of raw materials for glass was put in a platinum crucible and melted at 1,700° C. and degassed. The resultant glass was poured onto a carbon board to obtain a glass block. A part of each of the obtained blocks was used for evaluation, and the results thereof are shown in Table 1. Each blank in the tables indicates that the property was not evaluated.

### Preparation and Evaluation of Glass Ceramics

The obtained glass blocks were processed into 50 mm×50 mm×1.5 mm and then heat-treated under the conditions shown in Table 1 to obtain glass ceramics. In the row “Crystallization conditions” in the table, the upper portion shows conditions for nucleus formation treatment and the lower portion shows conditions for crystal growth treatment. For example, “550-2” in the upper portion and “730-2” in the lower portion mean that the glass was held at 550° C. for 2 hours and then held at 730° C. for 2 hours. A part of each of the obtained glass ceramics was used to ascertain, by X-ray powder diffractometry, that lithium metasilicate was contained.

The obtained glass ceramics were processed and mirror-polished to obtain glass-ceramic sheets having a thickness t of 0.7 mm. Furthermore, rod-shaped samples for determining the coefficient of thermal expansion were prepared. A part of each remaining glass ceramic was pulverized and used for analyzing precipitated crystals. The results of the evaluation of the glass ceramics are shown in Table 1, in which each blank shows that the property was not evaluated.

### Preparation and Evaluation of Chemically Strengthened Glasses

The obtained glass ceramics were subjected to chemical strengthening treatments under the strengthening conditions shown in Table 2 to obtain chemically strengthened glasses. Examples 1 to 4 are working examples, and Example 5 is a comparative example. In Table 1, “Na 100%” indicates a molten salt consisting of 100% sodium nitrate, “Na 99.7% Li 0.3%” indicates a molten salt obtained by mixing 99.7 wt % sodium nitrate with 0.3 wt % lithium nitrate, and “K 100%” means a molten salt consisting of 100% potassium nitrate. The obtained chemically strengthened glasses were evaluated, and the results thereof are shown in Table 2, in which each blank shows that the property was not evaluated.

### Evaluation Methods

### Glass Transition Point Tg, Coefficient of Thermal Expansion

In accordance with JIS R1618:2002, a thermal-expansion curve was obtained using a thermodilatometer (TD5000SA, manufactured by Bruker AXS K.K.) under the conditions of a heating rate of 10° C./min. From the obtained thermal-expansion curve were determined a glass transition point Tg [unit: ° C.] and a coefficient of thermal expansion.

### Specific Gravity

Specific gravity was determined by the Archimedes' method.

### Young's Modulus

Young's modulus was measured by an ultrasonic wave method.

### Refractive Index

A sample was mirror-polished to 15 mm×15 mm×0.8 mm and examined for refractive index with precision refractometer KPR-2000 (manufactured by Shimadzu Device Corp.) by a V-block method.

### Vickers Hardness

Vickers hardness was measured in accordance with the test method specified in JIS-Z-2244 (2009) (ISO 6507-1, ISO 6507-4, ASTM-E-384) using a Vickers hardness meter (MICRO HARDNESS TESTERHMV-2) manufactured by SHIMADZU in an ordinary-temperature ordinary-humidity environment (in this case, the temperature and the humidity were kept at 25° C. and 60% RH). The measurement was made on ten portions per sample, and an average for the ten portions was taken as the Vickers hardness of the sample. The Vickers indenter was forced into the sample for 15 seconds at an indenting load of 0.98 N.

### Fracture Toughness Value

A sample having dimensions of 6.5 mm×6.5 mm×65 mm was prepared and examined for fracture toughness value by the DCDC method. In preparation for the evaluation, a through hole having a diameter of 2 mm was formed in 65 mm×6.5 mm surface of the sample.

### Total Visible-Light Transmittance

Using a configuration including a spectrophotometer (LAMBDA950, manufactured by PerkinElmer, Inc.) and an integrating-sphere unit (150 mm; InGaAs Int. Sptere) as a detector, a glass-ceramic sheet was examined for transmittance over a wavelength range of 380-780 nm. In the examination, the glass sheet was kept in close contact with the integrating sphere and the transmitted light including diffused transmitted light was detected. The average transmittance which was an arithmetic average of the transmittances is shown as the visible-light transmittance [unit: %].

### Haze

A hazemeter (HZ-V3, manufactured by Suga Test Instruments Co., Ltd.) was used to measure haze [unit: %] under an illuminant C by a method according to JIS K 7136 (2000).

### X-Ray Diffractometry: Precipitated Crystals and Degree of Crystallization

Each sample was examined by X-ray powder diffractometry under the following conditions to identify the precipitated crystals. Furthermore, the degree of crystallization was calculated from the obtained diffraction intensities by the Rietveld method.

Measuring apparatus: SmartLab, manufactured by Rigaku Corp.

X-ray used: CuKα ray

Measuring range: 2θ=10°-80°

Speed: 10° C./min

Step: 0.02°

The detected crystals are shown in the row “Main crystals” in Table 1, where LS indicates lithium metasilicate.

### Stress Profile

First, a stress profile was obtained using measuring device SLP-2000, manufactured by Orihara Industrial Co., Ltd., and stress properties (compressive stress value C₅₅₀ [unit: MPa] at a depth of 50 μm; CT [unit: MPa]; and depth DOL [unit: μm] at which the compressive stress value was zero) were determined therefrom. With respect to the obtained stress profile, the gradient (MPa/μm) of the stress curve in the thickness range of DOL±10 μm and the gradient (MPa/μm) of the stress curve in the thickness range of [sheet-thickness center]±0.20×t (μm) were calculated for each 2-μm portion, and the largest value of the absolute values of the gradients was determined. Meanwhile, by a method in which birefringence imaging system Abrio-IM, manufactured by Tokyo Instruments, Inc., and a thinned sample were used, the sample was analyzed for glass-surface compressive stress value CS₀ [unit: MPa] and the position (μm) of an inflection point of the compressive stress curve lying between a main surface and the DOL. The results thereof are shown in Table 2. The stress profile of Example 1 is shown in FIG. 3.

In the method in which Abrio-IM and a thinned sample were used, the sheet-thickness resulting from the thinning was 0.5 mm. In order to correct stress fluctuations due to the thinning, the obtained stress profile was used after having been multiplied by 1/(1−v), where v is the Poisson's ratio of the glass.

### Ion Concentration with EPMA

Ion concentrations in a glass surface were determined using an EPMA (JXA-8500F, manufactured by JEOL). A sample was chemically strengthened, thereafter embedded in a resin, and then mirror-polished so that a section thereof parallel to the sheet-thickness-direction was exposed. Ion concentrations were calculated on the assumption that the position of an outermost surface was a position where the intensity of signals of Si, which was thought to change little in content, was one-half the signal intensity at the sheet-thickness center, that signal intensities at the sheet-thickness center corresponded to the glass composition of before the strengthening, and that the ion concentrations were proportional to signal intensity. In Table 2 are shown the gradient of the obtained Na concentration curve in the sheet-thickness-direction range of DOL±10 μm and whether there was an inflection point in the sheet-thickness-direction range lying between the first main surface and the depth where the compressive stress value was 0. Furthermore, signal intensities of main ions in Example 1 are shown in FIG. 4A, and a calculated Na ion concentration profile is shown in FIG. 4B. In FIG. 4B, the Na ion concentration at the sheet-thickness center had been taken as two times the Na₂O concentration in the glass composition.

### Weatherability Test

A sample was allowed to stand for 10 hours at 80° C. and a humidity of 80% and then examined for haze. Although not changed by a chemical strengthening treatment, the haze increases upon 120-hour standing at 80° C. and a humidity of 80%. The difference in haze between before and after the test (i.e., |(haze [%] after test)−(haze [%] before test)|) is shown as [Haze change (%)] in Table 2.

### Number of Fragments

Using a Vickers tester, a Vickers indenter having a tip angle of 90° was forced into a center portion of a test glass sheet to fracture the glass sheet. The number of fragments was then counted. (If the glass sheet was broken into two pieces, the number of fragments is 2.)

In cases when exceedingly fine fragments were formed, only fragments which did not pass through a 1 mm sieve were counted to determine the number of fragments.

The test was initiated with a Vickers-indenter indenting load of 3 kgf. In cases when the glass sheet did not break, the indenting load was increased by 1 kgf, and the test was repeated until the glass sheet broke. The number of fragments was counted at the time of first breakage.

### Drop Test

In a drop test, an obtained glass sample having dimensions of 120 mm×60 mm×0.6 mm (thickness) was fitted into a structure regulated so as to have a size, mass, and rigidity of a general smartphone in current use. A pseudo smartphone was thus prepared and dropped freely onto #180 SiC sandpaper. The pseudo smartphone was dropped from a height of 5 cm, and in cases when the glass did not break, the pseudo smartphone was dropped again from a height elevated by 5 cm. This operation was repeated until the glass broke. The height which resulted in first breakage was determined, and an average for ten glass sheets is shown in Table 1.

TABLE 1

| | | Example 1 | Example 2 | Example 3 | Example 4 | Example 5 |
|---|---|---|---|---|---|---|
| Thickness t (mm) | | 0.7 | 0.7 | 0.7 | 0.7 | 0.7 |
| Composition | SiO₂ | 54.9 | 51.0 | 56.5 | 54.9 | 54.9 |
| (mol %) | P₂O₅ | 2.3 | 2.3 | 2.3 | 2.3 | 2.3 |
| | Al₂O₃ | 1.1 | 4.0 | 1.1 | 1.1 | 1.1 |
| | Li₂O | 34.1 | 34.1 | 34.1 | 34.1 | 34.1 |
| | K₂O | 1.2 | 1.2 | 1.2 | 1.2 | 1.2 |
| | ZrO₂ | 4.5 | 4.5 | 3.0 | 4.5 | 4.5 |
| | CeO₂ | 0.0 | 0.0 | 0.0 | 0.0 | 0.0 |
| | Na₂O | 1.8 | 1.8 | 1.8 | 1.8 | 1.8 |
| | Y₂O₃ | 0.0 | 1.0 | 0.0 | 0.0 | 0.0 |
| | B₂O₃ | 0.0 | 0.0 | 0.0 | 0.0 | 0.0 |
| Properties | Tg (° C.) | 453 | 470 | 448 | 453 | 453 |
| before | Coefficient of thermal | 125 | 123 | 128 | 125 | 125 |
| crystallization | expansion (×10⁻⁷/K) | | | | | |
| | Specific gravity (g/cm³) | 2.5182 | 2.5935 | 2.474 | 2.5182 | 2.5182 |
| | Young's modulus (GPa) | 87 | 90 | 87 | 87 | 87 |
| | Refractive index | 1.5656 | 1.5768 | 1.5547 | 1.5656 | 1.5656 |
| | Vickers hardness (HV) | 604 | 597 | 586 | 604 | 604 |
| Crystallization conditions | | 550-2 | 550-2 | 550-2 | 550-2 | 550-2 |
| | | 730-2 | 710-2 | 710-2 | 730-2 | 730-2 |
| Properties | Haze (%) | 0.08 | 0.08 | 0.08 | 0.08 | 0.08 |
| after | Tg (° C.) | 627 | 646 | 638 | 627 | 627 |
| crystallization | Coefficient of thermal | 134 | 127 | 128 | 134 | 134 |
| | expansion (×10⁻⁷/K) | | | | | |
| | Specific gravity (g/cm³) | 2.585 | 2.6571 | 2.538 | 2.585 | 2.585 |
| | Young's modulus (GPa) | 104 | 104 | 103 | 104 | 104 |
| | Refractive index | 1.5757 | 1.5853 | 1.5639 | 1.5757 | 1.5757 |
| | Vickers hardness (HV) | 801 | 745 | 769 | 801 | 801 |
| | Fracture toughness value | 0.93 | 0.9 | 0.95 | 0.93 | 0.93 |
| | (MPa · m^{1/2}) | | | | | |
| | Degree of crystallization (%) | 23 | 21 | 29 | 23 | 23 |

TABLE 2

| | | Example 1 | Example 2 | Example 3 | Example 4 | Example 5 |
|---|---|---|---|---|---|---|
| Conditions for chemical strengthening | | Li 0.3 wt % | Li 0.9 wt % | Li 0.3 wt % | Na 100 wt % | Li 0.3 wt % |
| | | Na 99.7 wt % | Na 99.1 wt % | Na 99.7 wt % | 450° C. | Na 99.7 wt % |
| | | 450° C. | 450° C. | 450° C. | 1.0 hour | 450° C. |
| | | 2.4 hours | 3.8 hours | 2.4 hours | | 1 hour + |
| | | | | | | Annealing |
| Evaluation | Gradient of stress curve in | −6.7 | −5.5 | −7.3 | −9.2 | −6.4 |
| results | DOL ± 10 μm, (MPa/μm) | | | | | |
| | Gradient of Na concentration | −0.055 | −0.042 | −0.057 | −0.073 | −0.058 |
| | curve in DOL ± 10 μm, (μm⁻¹) | | | | | |
| | Gradient of stress curve in [sheet- | 0.010 | 0.020 | 0.010 | 0.030 | 0.010 |
| | thickness center] ± 0.20 × | | | | | |
| | [thickness t (μm)], (MPa/μm) | | | | | |
| | Position of inflection point in | 21 | >15 | >15 | 2.1 | 24 |
| | compressive stress curve between | | | | | |
| | main surface and DOL, (μm) | | | | | |
| | Presence or absence of inflection | No | No | No | No | There was |
| | point in Na concentration curve | Inflection | Inflection | Inflection | Inflection | inflection |
| | between main surface and DOL | point | point | point | point | point |
| | CS₀ (MPa) | 580 | 510 | 550 | 720 | 510 |
| | CS₅₀ (MPa) | 185 | 167 | 181 | 122 | 105 |
| | CT (MPa) | −82 | −84 | −83 | −84 | −65 |
| | DOL (μm) | 85 | 104 | 88 | 62 | 78 |
| | Weatherability [Haze change (%)] | 1.1 | 1.4 | 1.8 | 1.3 | 1 |
| | Number of fragments | 7 | 6 | 9 | 5 | 2 |
| | Drop test (cm) | 97 | 93 | 107 | 75 | 67 |

As Table 2 shows, since Examples 1 to 4, which are working examples, each had an Na concentration gradient and a stress gradient that were respectively within the ranges specified in the present invention, whereby Examples 1 to 4 each had a stress profile similar to that of conventional lithium-free glasses, although containing Li₂O in an amount of 10 mol % or more, and were inhibited from fracturing upon reception of damage and excellent in strength and weatherability, as compared with the comparative example. Furthermore, Examples 1 to 3 each had a compressive stress curve containing an inflection point in the sheet-thickness-direction range lying between a position having a depth of 10 μm from the first main surface and the depth where the compressive stress value was 0, and exhibited a higher strength than Example 4, in which the compressive stress curve contained no inflection point in that range.

While the present invention has been described in detail with reference to specific embodiments thereof, it will be apparent to one skilled in the art that various changes and modifications can be made therein without departing from the spirit and scope thereof.

1. A chemically strengthened glass having a first main surface, a second main surface facing the first main surface, and an end portion in contact with both the first main surface and the second main surface, and
satisfying the following (1a) to (4a) when compressive stress values of an inner portion of the glass are expressed using a depth from the first main surface as a variable:
(1a) in a thickness range of [depth where a compressive stress value is 0]±10 μm, a stress curve has a gradient of −15 MPa/μm to −3 MPa/μm and an Na concentration curve defined below has a gradient of 0.02/μm to 0.12/μm in terms of absolute value,
where the Na concentration curve is an Na concentration curve obtained by converting a sheet-thickness-direction Na ion concentration profile of the chemically strengthened glass determined with an EPMA into a curve expressed in mole percentage on an oxide basis;
(2a) the Na concentration curve, in a sheet-thickness-direction range lying between the first main surface and the depth where the compressive stress value is 0, has a monotonously decreasing gradient;
(3a) the chemically strengthened glass has a thickness of 1 mm or less; and
(4a) the chemically strengthened glass comprises Li₂O in an amount of 10 mol % or more in mole percentage on an oxide basis.

2. The chemically strengthened glass according to claim 1, wherein, when the thickness of the chemically strengthened glass is t (μm), the stress curve has an average gradient of less than 1 MPa/μm in terms of absolute value in a sheet-thickness-direction range lying between a sheet-thickness center tc (μm) and (tc−0.20×t) (μm).

3. The chemically strengthened glass according to claim 1, wherein in a sheet-thickness-direction range lying between the first main surface and the depth where the compressive stress value is 0, a compressive stress curve determined with birefringence imaging system Abrio-IM, manufactured by Tokyo Instruments, Inc., contains an inflection point and the Na concentration curve contains no inflection point.

4. The chemically strengthened glass according to claim 3, wherein in a sheet-thickness-direction range lying between a position having a depth of 10 μm from the first main surface and the depth where the compressive stress value is 0, the compressive stress curve contains an inflection point.

5. The chemically strengthened glass according to claim 1, which is a glass ceramic.

6. The chemically strengthened glass according to claim 5, wherein the glass ceramic has a degree of crystallization of 10% or more.

7. The chemically strengthened glass according to claim 5, wherein the glass ceramic comprises lithium metasilicate crystals.

8. The chemically strengthened glass according to claim 5, having a haze for transmitted-light as converted into a value corresponding to a thickness of 0.7 mm determined through a measurement method according to JIS K 7136 (2000) of 0.01-0.2%.

9. The chemically strengthened glass according to claim 5, having a visible-light transmittance as converted into a value corresponding to a thickness of 0.7 mm of 85% or more.

10. A method of producing a chemically strengthened glass, the method comprising chemically strengthening a glass that has a first main surface, a second main surface facing the first main surface, and an end portion in contact with both the first main surface and the second main surface, has a thickness of 1 mm or less, and comprises Li₂O in an amount of 10 mol % or more in mole percentage on an oxide basis,
wherein the chemical strengthening is chemical strengthening with a strengthening salt comprising sodium and having a potassium content of less than 5 mass %, and
the chemically strengthened glass to be obtained satisfies the following (1b) and (2b) when compressive stress values of an inner portion of the glass are expressed using a depth from the first main surface as a variable:
(1b) in a thickness range of [depth where compressive stress value is 0]±10 a stress curve has a gradient of −15 MPa/μm to −3 MPA/μm and an Na concentration curve defined below has a gradient of 0.02/μm to 0.12/μm in terms of absolute value,
where the Na concentration curve is an Na concentration curve obtained by converting a sheet-thickness-direction Na ion concentration profile of the chemically strengthened glass determined with an EPMA into a curve expressed in mole percentage on an oxide basis; and
(2b) the Na concentration curve, in a sheet-thickness-direction range lying between the first main surface and the depth where the compressive stress value is 0, has a monotonously decreasing gradient.

11. The method of producing a chemically strengthened glass according to claim 10, wherein the glass is a glass ceramic.

12. The method of producing a chemically strengthened glass according to claim 11, wherein the glass ceramic comprises, in mole percentage on an oxide basis:
40-65% of SiO₂;
0-10% of Al₂O₃;
20-40% of Li₂O;
0-10% of Na₂O; and
0.1-10% of K₂O.

13. The method of producing a chemically strengthened glass according to claim 11, wherein the glass ceramic has a visible-light transmittance as converted into a value corresponding to a thickness of 0.7 mm of 85% or more.

14. The method of producing a chemically strengthened glass according to claim 11, wherein the glass ceramic comprises lithium metasilicate crystals.
